(19) United States
(12) Patent Application Publication
(10) Pub. No.: US 2011/0002114 A1
(43) Pub. Date: Jan. 6, 2011

(54) LED-BASED ILLUMINATION SYSTEM FOR HEAT-SENSITIVE OBJECTS

(75) Inventor: Brad Eric Koerner, Boise, ID (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/667,943

(22) PCT Filed: Jul. 7, 2008
(86) PCT No.: PCT/US08/69338

§ 371 Date: Jan. 6, 2010

Related U.S. Application Data
(60) Provisional application No. 60/950,152, filed on Jul. 17, 2007.

(51) Int. Cl. F21V 29/02

(52) U.S. Cl. 362/126

(57) ABSTRACT

Disclosed herein are illumination systems (300) employing LED-based light sources that are suitable for illuminating display cases (310) containing museum-quality artifacts or other heat-sensitive objects. Taking advantage of compact size and unique thermal properties of LED light sources, these illumination systems are configured to direct focused and/or diffuse illumination into a hermetically-sealed enclosure without introducing undesirable heat. These illumination systems may also include a transparent insulative barrier (400) and forced-air convection-cooling system (480).

### BACKGROUND

Museums and other galleries often utilize hermetically-sealed display cases for showcasing fine antiquities, art, or other artifacts. In addition to avoiding dust infiltration and preventing theft, these cases are configured to maintain very strict temperature and humidity ranges to preserve the artifacts. The cases also require very precise, adjustable, focused lighting to properly illuminate the artifacts on display. Because of the inherent reflections and subsequent veiling glare caused by illumination sources located on the exterior of the glass-enclosed case, the illumination source should preferably be located within the case itself. However, since all conventional electric illumination sources generate heat, it is problematic to include them directly in the case.

One known approach for display illumination employs fiber optic systems that channel light into a display case from a remotely located source. A single, high-power light source is focused into bundled strings of glass or plastic optical fibers, which are routed into the case and, via secondary focusing optics, are aimed at the individual artifacts. However, these complex systems are very expensive and suffer from a number of shortcomings. First, it is fundamentally difficult to channel a high-power omnidirectional light source into a narrow aperture in a collinear beam, resulting in tremendous optical inefficiencies. Further, because these light sources have to be extremely powerful to make the system economically feasible, they run very hot and have to be actively cooled. Finally, illuminators in fiber optic systems generally have relatively short lifetimes, which, considering their high capital and operating costs, limits commercial appeal of this approach.

Advent of digital lighting technologies, i.e. illumination based on semiconductor light sources, such as light-emitting diodes (LEDs), offers a viable alternative to traditional fluorescent, HID, and incandescent lamps in a variety of applications. Functional advantages and benefits of LEDs include high energy conversion and optical efficiency, unparallel operating life, compactness, lower operating costs, and many others. Notably, LEDs generally emit no heat in their direct beam of light, dissipating heat on the back side of the die.

### SUMMARY

The technology disclosed herein generally relates to lighting fixtures employing LED-based light sources that are suitable for illuminating display cases containing museum-quality artifacts. More particularly, this technology is directed to an illumination system taking advantage of compact size and unique thermal properties of LED light sources to direct focused illumination into a hermetically-sealed enclosure without introducing undesirable heat. In many implementations, the illumination system includes a transparent insulative barrier and forced-air convection-cooling system.

This technology also relates to systems and methods for generating and/or modulating illumination conditions to generate light of a desired and controllable color, for creating lighting fixtures for producing light in desirable and reproducible colors, and for modifying the color temperature or color shade of light produced by a lighting fixture within a pre-specified range after a lighting fixture is constructed. In various implementations, LED lighting units capable of generating light of a range of colors are used to provide light or supplement ambient light to achieve lighting conditions most suitable for illuminating artifacts on display.

Generally, the technology disclosed herein focuses on an illumination system suitable for mounting over an aperture of an enclosure, for example, a display case. The system includes a thermally resistant housing shaped to be received and secured within the aperture. The housing is separated, by a heat-dissipating partition, into two chambers in relation to the enclosure, a proximal chamber and a distal chamber. The partition is made, for example, of aluminum and defines at least one opening formed therethrough.

The system further includes at least one first lighting unit having a heat-dissipating portion and at least one second lighting unit. Each of the lighting units includes a first plurality of LED light sources and adapted to generate at least first radiation having a first spectrum. In some implementations, at least one of the lighting units also includes a second plurality of LED light sources adapted to generate at least second radiation having a second spectrum different than the first spectrum. The first lighting unit is secured in the opening formed in the partition such that the heat-dissipating portion thereof is disposed in the distal chamber and the light sources are disposed in the proximal chamber, projecting light into the enclosure through the aperture. In some implementations, the first lighting unit is rotatable about an axis for directing a beam of light at a desired spot within the enclosure, for example, on an artifact in the display case. The second lighting unit is disposed in the proximal chamber and is fixedly attached to the partition.

Generally, in one aspect, the invention relates to an illumination system for illuminating one or more heat-sensitive objects disposed in a display case. The illumination system includes a thermally insulated housing including a partition at least partially defining a proximal chamber and a distal chamber of the housing. The illumination system also includes a first lighting unit attached to the partition and disposed within the housing, the first lighting unit comprising a first plurality of LED light sources disposed within the proximal chamber and configured to generate a first radiation having a first spectrum for illuminating the one or more objects. The illumination system further includes a control module is also included for controlling at least the first plurality of LED light sources, a first heat-dissipating member at least partially disposed within the distal chamber in thermal communication with the first plurality of LED light sources; and a cooling system configured to cause an airflow through the distal chamber for cooling the heat-dissipating member.

Various embodiments of this aspect of the invention include at least some of the following features. The first lighting unit may also include a second plurality of LED light sources adapted to generate a second radiation having a second spectrum different from the first spectrum. Also, the illumination system may include a second lighting unit attached to the partition and disposed within the housing, the second lighting unit having a third plurality of LED light sources configured to generate a third radiation having a third spectrum for illuminating the one or more objects. The second lighting unit can be configured to generate a light beam having a beam angle within a range of 40 to 70 degrees for providing ambient illumination within the display case.

In some embodiments, the first lighting unit is attached to the partition with an adjustable orientation so as to direct a light beam at a desired limited area within the case. The light beam generated by the first lighting unit may have a beam angle within a range of 5 to 20 degrees, for example, 10 degrees.

In some embodiments, the partition is thermally conductive and defines a second heat-dissipating member comprising a plurality of fins The system also includes a cooling system, for example, a fan disposed in the distal chamber for providing a forced-air convection cooling of the lighting units. The system further includes a control module for controlling the light sources disposed in the proximal chamber and a light-transmissive panel sealably separating the proximal chamber from the enclosure. The light-transmissive panel is preferably removable or pivotable for providing access to the control module and the lighting units.

Generally, in another aspect, the invention features a housing for securing at least one lighting unit and at least one control module for illuminating at least one heat-sensitive object. The housing includes opposing side walls; a top wall connected to the side walls; a partition extending between the side walls and opposing the top wall, the partition being adapted to receive the at least one lighting unit and the at least one control module; wherein the opposing side walls, the top wall, and a first surface of the partition define a distal chamber and a first pair of opposing openings for allowing air flow through the distal chamber; wherein the opposing side walls and a second surface of the partition define a proximal chamber and a second pair of opposing openings; and a pair of opposing end walls covering only the second pair of opposing openings for preventing airflow through the proximal chamber.

In yet another aspect, the invention focuses on a method for illuminating a heat-sensitive object within a display case, which includes the steps of
(a) providing a housing defining a proximal chamber proximate to the heat-sensitive object and a distal chamber distal from the heat-sensitive object;
(b) disposing within the housing at least one lighting unit having a plurality of LED light sources and a heat-dissipating member in thermal communication with the plurality of LED light sources, such that the heat-dissipating member is disposed within the distal chamber;
(c) causing the plurality of LED light sources to direct a light beam towards the heat-sensitive object;
(d) creating an airflow through the distal chamber but not through the proximal chamber, thereby enhancing conductive heat transfer from the LED light sources to the heat-dissipating member and enhancing convective heat transfer from the heat-dissipating member to the ambient; and
(e) thereafter, exhausting the heated air away from the heat-sensitive object.

The plurality of LED light sources can be configured to generate radiation having a variable spectrum. Step (c) may include controlling the radiation generated by the plurality of LED light sources to select a desirable spectrum. The method may also include providing diffuse illumination within the case.

### Relevant Terminology

As used herein for purposes of the present disclosure, the term “LED” should be understood to include any electroluminescent diode or other type of carrier injection/junction-based system that is capable of generating radiation in response to an electric signal. Thus, the term LED includes, but is not limited to, various semiconductor-based structures that emit light in response to current, light emitting polymers, organic light emitting diodes (OLEDs), electroluminescent strips, and the like.

In particular, the term LED refers to light emitting diodes of all types (including semi-conductor and organic light emitting diodes) that may be configured to generate radiation in one or more of the infrared spectrum, ultraviolet spectrum, and various portions of the visible spectrum (generally including radiation wavelengths from approximately 400 nanometers to approximately 700 nanometers). Some examples of LEDs include, but are not limited to, various types of infrared LEDs, ultraviolet LEDs, red LEDs, blue LEDs, green LEDs, yellow LEDs, amber LEDs, orange LEDs, and white LEDs (discussed further below). It also should be appreciated that LEDs may be configured and/or controlled to generate radiation having various bandwidths (e.g., full widths at half maximum, or FWHM) for a given spectrum (e.g., narrow bandwidth, broad bandwidth), and a variety of dominant wavelengths within a given general color categorization.

For example, one implementation of an LED configured to generate essentially white light (e.g., a white LED) may include a number of dies which respectively emit different spectra of electroluminescence that, in combination, mix to form essentially white light. In another implementation, a white light LED may be associated with a phosphor material that converts electroluminescence having a first spectrum to a different second spectrum. In one example of this implementation, electroluminescence having a relatively short wavelength and narrow bandwidth spectrum “pumps” the phosphor material, which in turn radiates longer wavelength radiation having a somewhat broader spectrum.

It should also be understood that the term LED does not limit the physical and/or electrical package type of an LED. For example, as discussed above, an LED may refer to a single light emitting device having multiple dies that are configured to respectively emit different spectra of radiation (e.g., that may or may not be individually controllable). Also, an LED may be associated with a phosphor that is considered as an integral part of the LED (e.g., some types of white LEDs). In general, the term LED may refer to packaged LEDs, non-packaged LEDs, surface mount LEDs, chip-on-board LEDs, T-package mount LEDs, radial package LEDs, power package LEDs, LEDs including some type of encasement and/or optical element (e.g., a diffusing lens), etc.

A given light source may be configured to generate electromagnetic radiation within the visible spectrum, outside the visible spectrum, or a combination of both. Hence, the terms “light” and “radiation” are used interchangeably herein. Additionally, a light source may include as an integral component one or more filters (e.g., color filters), lenses, or other optical components. Also, it should be understood that light sources may be configured for a variety of applications, including, but not limited to, indication, display, and/or illumination. An “illumination source” is a light source that is particularly configured to generate radiation having a sufficient intensity to effectively illuminate an interior or exterior space. In this context, “sufficient intensity” refers to sufficient radiant power in the visible spectrum generated in the space or environment (the unit “lumens” often is employed to represent the total light output from a light source in all directions, in terms of radiant power or “luminous flux”) to provide ambient illumination (i.e., light that may be perceived indirectly and that may be, for example, reflected off of one or more of a variety of intervening surfaces before being perceived in whole or in part).

The term “spectrum” should be understood to refer to any one or more frequencies (or wavelengths) of radiation produced by one or more light sources. Accordingly, the term “spectrum” refers to frequencies (or wavelengths) not only in the visible range, but also frequencies (or wavelengths) in the infrared, ultraviolet, and other areas of the overall electromagnetic spectrum. Also, a given spectrum may have a relatively narrow bandwidth (e.g., a FWHM having essentially few frequency or wavelength components) or a relatively wide bandwidth (several frequency or wavelength components having various relative strengths). It should also be appreciated that a given spectrum may be the result of a mixing of two or more other spectra (e.g., mixing radiation respectively emitted from multiple light sources). For purposes of this disclosure, the term “color” is used interchangeably with the term “spectrum.” However, the term “color” generally is used to refer primarily to a property of radiation that is perceivable by an observer (although this usage is not intended to limit the scope of this term). Accordingly, the terms “different colors” implicitly refer to multiple spectra having different wavelength components and/or bandwidths. It also should be appreciated that the term “color” may be used in connection with both white and non-white light.

The term “color temperature” generally is used herein in connection with white light, although this usage is not intended to limit the scope of this term. Color temperature essentially refers to a particular color content or shade (e.g., reddish, bluish) of white light. The color temperature of a given radiation sample conventionally is characterized according to the temperature in degrees Kelvin (K) of a black body radiator that radiates essentially the same spectrum as the radiation sample in question. Black body radiator color temperatures generally fall within a range of from approximately 700 degrees K (typically considered the first visible to the human eye) to over 10,000 degrees K; white light generally is perceived at color temperatures above 1500-2000 degrees K.

Lower color temperatures generally indicate white light having a more significant red component or a “warmer feel,” while higher color temperatures generally indicate white light having a more significant blue component or a “cooler feel.” By way of example, fire has a color temperature of approximately 1,800 degrees K, a conventional incandescent bulb has a color temperature of approximately 2848 degrees K, early morning daylight has a color temperature of approximately 3,000 degrees K, and overcast midday skies have a color temperature of approximately 10,000 degrees K. A color image viewed under white light having a color temperature of approximately 3,000 degree K has a relatively reddish tone, whereas the same color image viewed under white light having a color temperature of approximately 10,000 degrees K has a relatively bluish tone.

The term “lighting fixture” is used herein to refer to an implementation or arrangement of one or more lighting units in a particular form factor, assembly, or package. The term “lighting unit” is used herein to refer to an apparatus including one or more light sources of same or different types. A given lighting unit may have any one of a variety of mounting arrangements for the light source(s), enclosure/housing arrangements and shapes, and/or electrical and mechanical connection configurations. Additionally, a given lighting unit optionally may be associated with (e.g., include, be coupled to and/or packaged together with) various other components (e.g., control circuitry) relating to the operation of the light source(s). An “LED-based lighting unit” refers to a lighting unit that includes one or more LED-based light sources as discussed above, alone or in combination with other non LED-based light sources. A “multi-channel” lighting unit refers to an LED-based or non LED-based lighting unit that includes at least two light sources configured to respectively generate different spectrums of radiation, wherein each different source spectrum may be referred to as a “channel” of the multi-channel lighting unit.

The term “controller” is used herein generally to describe various apparatus relating to the operation of one or more light sources. A controller can be implemented in numerous ways (e.g., such as with dedicated hardware) to perform various functions discussed herein. A “processor” is one example of a controller which employs one or more microprocessors that may be programmed using software (e.g., microcode) to perform various functions discussed herein. A controller may be implemented with or without employing a processor, and also may be implemented as a combination of dedicated hardware to perform some functions and a processor (e.g., one or more programmed microprocessors and associated circuitry) to perform other functions. Examples of controller components that may be employed in various embodiments of the present disclosure include, but are not limited to, conventional microprocessors, application specific integrated circuits (ASICs), and field-programmable gate arrays (FPGAs).

In various implementations, a processor or controller may be associated with one or more storage media (generically referred to herein as “memory,” e.g., volatile and non-volatile computer memory such as RAM, PROM, EPROM, and EEPROM, floppy disks, compact disks, optical disks, magnetic tape, etc.). In some implementations, the storage media may be encoded with one or more programs that, when executed on one or more processors and/or controllers, perform at least some of the functions discussed herein. Various storage media may be fixed within a processor or controller or may be transportable, such that the one or more programs stored thereon can be loaded into a processor or controller so as to implement various aspects of the present technology discussed herein. The terms “program” or “computer program” are used herein in a generic sense to refer to any type of computer code (e.g., software or microcode) that can be employed to program one or more processors or controllers.

The term “addressable” is used herein to refer to a device (e.g., a light source in general, a lighting unit or fixture, a controller or processor associated with one or more light sources or lighting units, other non-lighting related devices, etc.) that is configured to receive information (e.g., data) intended for multiple devices, including itself, and to selectively respond to particular information intended for it. The term “addressable” often is used in connection with a networked environment (or a “network,” discussed further below), in which multiple devices are coupled together via some communications medium or media.

In one network implementation, one or more devices coupled to a network may serve as a controller for one or more other devices coupled to the network (e.g., in a master/slave relationship). In another implementation, a networked environment may include one or more dedicated controllers that are configured to control one or more of the devices coupled to the network. Generally, multiple devices coupled to the network each may have access to data that is present on the communications medium or media; however, a given device may be “addressable” in that it is configured to selectively exchange data with (i.e., receive data from and/or transmit data to) the network, based, for example, on one or more particular identifiers (e.g., “addresses”) assigned to it.

The term “network” as used herein refers to any interconnection of two or more devices (including controllers or processors) that facilitates the transport of information (e.g. for device control, data storage, data exchange, etc.) between any two or more devices and/or among multiple devices coupled to the network. As should be readily appreciated, various implementations of networks suitable for interconnecting multiple devices may include any of a variety of network topologies and employ any of a variety of communication protocols. Additionally, in various networks according to the technology disclosed herein, any one connection between two devices may represent a dedicated connection between the two systems, or alternatively a non-dedicated connection. In addition to carrying information intended for the two devices, such a non-dedicated connection may carry information not necessarily intended for either of the two devices (e.g., an open network connection). Furthermore, it should be readily appreciated that various networks of devices as discussed herein may employ one or more wireless, wire/cable, and/or fiber optic links to facilitate information transport throughout the network.

The term “user interface” as used herein refers to an interface between a human user or operator and one or more devices that enables communication between the user and the device(s). Examples of user interfaces that may be employed in various implementations of the present technology include, but are not limited to, switches, potentiometers, buttons, dials, sliders, a mouse, keyboard, keypad, various types of game controllers (e.g., joysticks), track balls, display screens, various types of graphical user interfaces (GUIs), touch screens, microphones and other types of sensors that may receive some form of human-generated stimulus and generate a signal in response thereto.

It should also be appreciated that terminology explicitly employed herein that also may appear in any disclosure incorporated by reference below should be accorded a meaning most consistent with the particular inventive concepts disclosed herein.

### Related Patents and Patent Applications

The following patents and patent applications, relevant to the present technology and any inventive concepts contained therein, are hereby incorporated herein by reference:
U.S. Pat. No. 6,016,038, issued Jan. 18, 2000, entitled “Multicolored LED Lighting Method and Apparatus;”
U.S. Pat. No. 6,211,626, issued Apr. 3, 2001, entitled “Illumination Components;”
U.S. Pat. No. 6,777,891, issued Aug. 17, 2004, entitled “Methods and Apparatus for Controlling Devices in a Networked Lighting System;”
U.S. Pat. No. 6,975,079, issued Dec. 13, 2005, entitled “Systems and Methods for Controlling Illumination Sources;”
U.S. Pat. No. 6,965,205, issued Nov. 15, 2005, entitled “Light Emitting Diode Based Products;”
U.S. Pat. No. 7,014,336, issued Mar. 21, 2006, entitled “Systems and Methods for Generating and Modulating Illumination Conditions;”
U.S. Pat. No. 7,038,399, issued May 2, 2006, entitled “Methods and Apparatus for Providing Power to Lighting Devices;”
U.S. Pat. No. 7,256,554, issued Aug. 14, 2007, entitled “LED Power Control Methods and Apparatus;”
U.S. Pat. No. 7,344, 279, issued Mar. 18, 2008, entitled “Thermal Management Methods and Apparatus for Lighting Devices;”
U.S. patent application Ser. No. 11/419,995, filed May 23, 2006, entitled “Modular LED-Based Lighting Fixtures Having Socket Engagement Features;” and
U.S. patent application Ser. No. 11/625,622, Filed Jan. 22, 2007, entitled “Methods and Apparatus for Generating and Modulating White Light Illumination Conditions.”

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 is a diagram illustrating a controlled LED-based light source suitable for use with an illumination system disclosed herein.

FIG. 2 is a diagram illustrating a networked system of LED-based light sources of FIG. 1.

FIG. 3A illustrate a display case lit by the illumination system according to various implementation of the present technology.

FIG. 3B illustrate a top view of the display case of FIG. 3A.

FIGS. 4A-4B illustrate a cross-section and a top view, respectively, of the illumination system of FIG. 3A.

### DETAILED DESCRIPTION

Various implementations of the present technology and related inventive concepts are described below, including certain embodiments relating particularly to LED-based light sources. It should be appreciated, however, that the technology disclosed herein is not limited to any particular manner of implementation, and that the various embodiments discussed explicitly herein are primarily for purposes of illustration. For example, the various concepts discussed herein may be suitably implemented in a variety of environments involving LED-based light sources, other types of light sources not including LEDs, environments that involve both LEDs and other types of light sources in combination, and environments that involve non-lighting-related devices alone or in combination with various types of light sources.

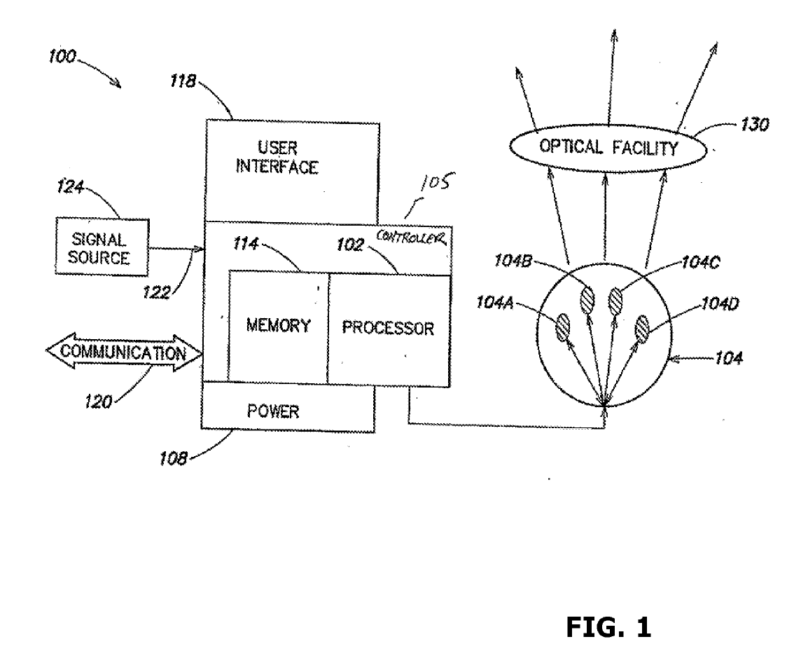

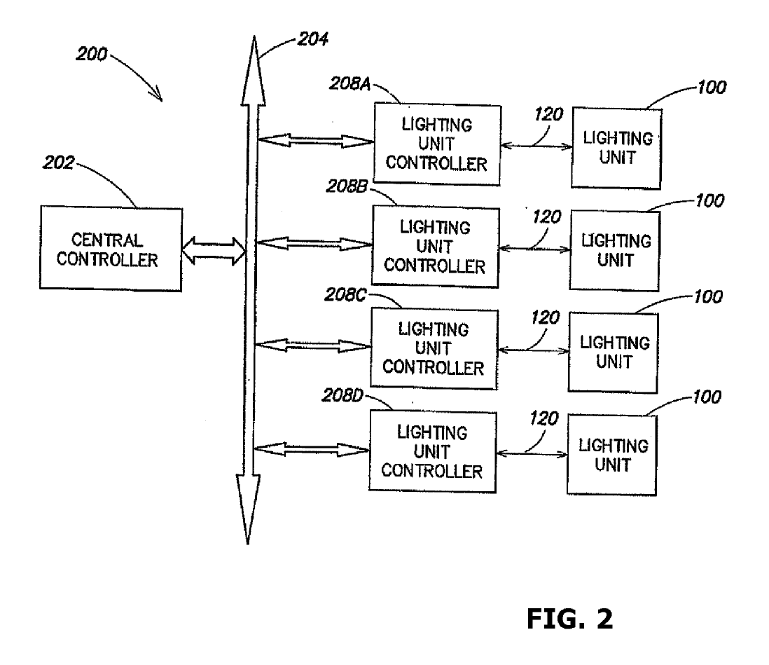

FIG. 1 illustrates one example of a lighting unit 100 that is suitable for use with an illumination system described herein. Some general examples of LED-based lighting units similar to those that are described below in connection with FIG. 1 may be found, for example, in U.S. Pat. No. 6,016,038, issued Jan. 18, 2000 to Mueller et al., entitled “Multicolored LED Lighting Method and Apparatus,” and U.S. Pat. No. 6,211,626, issued Apr. 3, 2001 to Lys et al, entitled “Illumination Components,” which patents are both hereby incorporated herein by reference. In various implementations, the lighting unit 100 shown in FIG. 1 may be used alone or together with other similar lighting units in a system of lighting units (e.g., as discussed further below in connection with FIG. 2). Used alone or in combination with other lighting units, the lighting unit 100 may be employed in a variety of applications.

The lighting unit 100 shown in FIG. 1 may include one or more light sources 104A, 104B, 104C, and 104D (shown collectively as 104), wherein one or more of the light sources may be an LED-based light source that includes one or more LEDs. Any two or more of the light sources may be adapted to generate radiation of different colors (e.g. red, green, blue); in this respect, as discussed above, each of the different color light sources generates a different source spectrum that constitutes a different “channel” of a “multi-channel” lighting unit. Although FIG. 1 shows four light sources 104A, 104B, 104C, and 104D, it should be appreciated that the lighting unit is not limited in this respect, as different numbers and various types of light sources (all LED-based light sources, LED-based and non-LED-based light sources in combination, etc.) adapted to generate radiation of a variety of different colors, including essentially white light, may be employed in the lighting unit 100, as discussed further below.

Still referring to FIG. 1, the lighting unit 100 also may include a controller 105 that is configured to output one or more control signals to drive the light sources so as to generate various intensities of light from the light sources. For example, in one implementation, the controller 105 may be configured to output at least one control signal for each light source so as to independently control the intensity of light (e.g., radiant power in lumens) generated by each light source; alternatively, the controller 105 may be configured to output one or more control signals to collectively control a group of two or more light sources identically. Some examples of control signals that may be generated by the controller to control the light sources include, but are not limited to, pulse modulated signals, pulse width modulated signals (PWM), pulse amplitude modulated signals (PAM), pulse code modulated signals (PCM) analog control signals (e.g., current control signals, voltage control signals), combinations and/or modulations of the foregoing signals, or other control signals. In some implementations, particularly in connection with LED-based sources, one or more modulation techniques provide for variable control using a fixed current level applied to one or more LEDs, so as to mitigate potential undesirable or unpredictable variations in LED output that may arise if a variable LED drive current were employed. In other implementations, the controller 105 may control other dedicated circuitry (not shown in FIG. 1) which in turn controls the light sources so as to vary their respective intensities.

In general, the intensity (radiant output power) of radiation generated by the one or more light sources is proportional to the average power delivered to the light source(s) over a given time period. Accordingly, one technique for varying the intensity of radiation generated by the one or more light sources involves modulating the power delivered to (i.e., the operating power of) the light source(s). For some types of light sources, including LED-based sources, this may be accomplished effectively using a pulse width modulation (PWM) technique.

In one exemplary implementation of a PWM control technique, for each channel of a lighting unit a fixed predetermined voltage V_{source} is applied periodically across a given light source constituting the channel. The application of the voltage V_{source} may be accomplished via one or more switches, not shown in FIG. 1, controlled by the controller 105. While the voltage V_{source} is applied across the light source, a predetermined fixed current I_{source} (e.g., determined by a current regulator, also not shown in FIG. 1) is allowed to flow through the light source. Again, recall that an LED-based light source may include one or more LEDs, such that the voltage V_{source} may be applied to a group of LEDs constituting the source, and the current I_{source} may be drawn by the group of LEDs. The fixed voltage V_{source} across the light source when energized, and the regulated current I_{source} drawn by the light source when energized, determines the amount of instantaneous operating power P_{source} of the light source (P_{source}=V_{source}·I_{source}). As mentioned above, for LED-based light sources, using a regulated current mitigates potential undesirable or unpredictable variations in LED output that may arise if a variable LED drive current were employed.

According to the PWM technique, by periodically applying the voltage V_{source} to the light source and varying the time the voltage is applied during a given on-off cycle, the average power delivered to the light source over time (the average operating power) may be modulated. In particular, the controller 105 may be configured to apply the voltage V_{source} to a given light source in a pulsed fashion (e.g., by outputting a control signal that operates one or more switches to apply the voltage to the light source), preferably at a frequency that is greater than that capable of being detected by the human eye (e.g., greater than approximately 100 Hz). In this manner, an observer of the light generated by the light source does not perceive the discrete on-off cycles (commonly referred to as a “flicker effect”), but instead the integrating function of the eye perceives essentially continuous light generation. By adjusting the pulse width (i.e. on-time, or “duty cycle”) of on-off cycles of the control signal, the controller varies the average amount of time the light source is energized in any given time period, and hence varies the average operating power of the light source. In this manner, the perceived brightness of the generated light from each channel in turn may be varied.

As discussed in greater detail below, the controller 105 may be configured to control each different light source channel of a multi-channel lighting unit at a predetermined average operating power to provide a corresponding radiant output power for the light generated by each channel. Alternatively, the controller 105 may receive instructions (e.g., “lighting commands”) from a variety of origins, such as a user interface 118, a signal source 124, or one or more communication ports 120, that specify prescribed operating powers for one or more channels and, hence, corresponding radiant output powers for the light generated by the respective channels. By varying the prescribed operating powers for one or more channels (e.g., pursuant to different instructions or lighting commands), different perceived colors and brightness levels of light may be generated by the lighting unit.

In some implementations of the lighting unit 100, as mentioned above, one or more of the light sources 104A, 104B, 104C, and 104D shown in FIG. 1 may include a group of multiple LEDs or other types of light sources (e.g., various parallel and/or serial connections of LEDs or other types of light sources) that are controlled together by the controller 105. Additionally, it should be appreciated that one or more of the light sources may include one or more LEDs that are adapted to generate radiation having any of a variety of spectra (i.e., wavelengths or wavelength bands), including, but not limited to, various visible colors (including essentially white light), various color temperatures of white light, ultraviolet, or infrared. LEDs having a variety of spectral bandwidths (e.g., narrow band, broader band) may be employed in various implementations of the lighting unit 100.

The lighting unit 100 may be constructed and arranged to produce a wide range of variable color radiation. For example, in one implementation, the lighting unit 100 may be particularly arranged such that controllable variable intensity (i.e., variable radiant power) light generated by two or more of the light sources combines to produce a mixed colored light (including essentially white light having a variety of color temperatures). In particular, the color (or color temperature) of the mixed colored light may be varied by varying one or more of the respective intensities (output radiant power) of the light sources (e.g., in response to one or more control signals output by the controller 105). Furthermore, the controller 105 may be particularly configured to provide control signals to one or more of the light sources so as to generate a variety of static or time-varying (dynamic) multi-color (or multi-color temperature) lighting effects. To this end, the controller may include a processor 102 (e.g., a microprocessor) programmed to provide such control signals to one or more of the light sources. In various implementations, the processor 102 may be programmed to provide such control signals autonomously, in response to lighting commands, or in response to various user or signal inputs.

Thus, the lighting unit 100 may include a wide variety of colors of LEDs in various combinations, including two or more of red, green, and blue LEDs to produce a color mix, as well as one or more other LEDs to create varying colors and color temperatures of white light. For example, red, green and blue can be mixed with amber, white, UV, orange, IR or other colors of LEDs. Additionally, multiple white LEDs having different color temperatures (e.g., one or more first white LEDs that generate a first spectrum corresponding to a first color temperature, and one or more second white LEDs that generate a second spectrum corresponding to a second color temperature different than the first color temperature) may be employed, in an all-white LED lighting unit or in combination with other colors of LEDs. Such combinations of differently colored LEDs and/or different color temperature white LEDs in the lighting unit 100 can facilitate accurate reproduction of a host of desirable spectrums of lighting conditions, examples of which include, but are not limited to, a variety of outside daylight equivalents at different times of the day, various interior lighting conditions, lighting conditions to simulate a complex multicolored background, and the like. Other desirable lighting conditions can be created by removing particular pieces of spectrum that may be specifically absorbed, attenuated or reflected in certain environments. Water, for example tends to absorb and attenuate most non-blue and non-green colors of light, so underwater applications may benefit from lighting conditions that are tailored to emphasize or attenuate some spectral elements relative to others.

As shown in FIG. 1, the lighting unit 100 also may include a memory 114 to store various data. For example, the memory 114 may be employed to store one or more lighting commands or programs for execution by the processor 102 (e.g., to generate one or more control signals for the light sources), as well as various types of data useful for generating variable color radiation (e.g., calibration information, discussed further below). The memory 114 also may store one or more particular identifiers (e.g., a serial number, an address, etc.) that may be used either locally or on a system level to identify the lighting unit 100. In various embodiments, such identifiers may be pre-programmed by a manufacturer, for example, and may be either alterable or non-alterable thereafter (e.g., via some type of user interface located on the lighting unit, via one or more data or control signals received by the lighting unit, etc.). Alternatively, such identifiers may be determined at the time of initial use of the lighting unit in the field, and again may be alterable or non-alterable thereafter.

One issue that may arise in connection with controlling multiple light sources in the lighting unit 100 of FIG. 1, and controlling multiple lighting units 100 in a lighting system (e.g., as discussed below in connection with FIG. 2), relates to potentially perceptible differences in light output between substantially similar light sources. For example, given two virtually identical light sources being driven by respective identical control signals, the actual intensity of light (e.g., radiant power in lumens) output by each light source may be measurably different. Such a difference in light output may be attributed to various factors including, for example, slight manufacturing differences between the light sources, normal wear and tear over time of the light sources that may differently alter the respective spectrums of the generated radiation, etc. For purposes of the present discussion, light sources for which a particular relationship between a control signal and resulting output radiant power are not known are referred to as “uncalibrated” light sources. The use of one or more uncalibrated light sources in the lighting unit 100 shown in FIG. 1 may result in generation of light having an unpredictable, or “uncalibrated,” color or color temperature. For example, consider a first lighting unit including a first uncalibrated red light source and a first uncalibrated blue light source, each controlled in response to a corresponding lighting command having an adjustable parameter in a range of from zero to 255 (0-255), wherein the maximum value of 255 represents the maximum radiant power available (i.e., 100%) from the light source. For purposes of this example, if the red command is set to zero and the blue command is non-zero, blue light is generated, whereas if the blue command is set to zero and the red command is non-zero, red light is generated. However, if both commands are varied from non-zero values, a variety of perceptibly different colors may be produced (e.g., in this example, at very least, many different shades of purple are possible). In particular, perhaps a particular desired color (e.g., lavender) is given by a red command having a value of 125 and a blue command having a value of 200. Now consider a second lighting unit including a second uncalibrated red light source substantially similar to the first uncalibrated red light source of the first lighting unit, and a second uncalibrated blue light source substantially similar to the first uncalibrated blue light source of the first lighting unit. As discussed above, even if both of the uncalibrated red light sources are controlled in response to respective identical commands, the actual intensity of light (e.g., radiant power in lumens) output by each red light source may be measurably different. Similarly, even if both of the uncalibrated blue light sources are controlled in response to respective identical commands, the actual light output by each blue light source may be measurably different.

With the foregoing in mind, it should be appreciated that if multiple uncalibrated light sources are used in combination in lighting units to produce a mixed colored light as discussed above, the observed color (or color temperature) of light produced by different lighting units under identical control conditions may be perceivably different. Specifically, consider again the “lavender” example above; the “first lavender” produced by the first lighting unit with a red command having a value of 125 and a blue command having a value of 200 indeed may be perceivably different than a “second lavender” produced by the second lighting unit with a red command having a value of 125 and a blue command having a value of 200. More generally, the first and second lighting units generate uncalibrated colors by virtue of their uncalibrated light sources. Accordingly, in some implementations of the present technology, the lighting unit 100 includes calibration means to facilitate the generation of light having a calibrated (e.g., predictable, reproducible) color at any given time. In one aspect, the calibration means is configured to adjust (e.g., scale) the light output of at least some light sources of the lighting unit so as to compensate for perceptible differences between similar light sources used in different lighting units. For example, in one embodiment, the processor 102 of the lighting unit 100 is configured to control one or more of the light sources so as to output radiation at a calibrated intensity that substantially corresponds in a predetermined manner to a control signal for the light source(s). As a result of mixing radiation having different spectra and respective calibrated intensities, a calibrated color is produced. In one aspect of this embodiment, at least one calibration value for each light source is stored in the memory 114, and the processor is programmed to apply the respective calibration values to the control signals (commands) for the corresponding light sources so as to generate the calibrated intensities. One or more calibration values may be determined once (e.g., during a lighting unit manufacturing/testing phase) and stored in the memory 114 for use by the processor 102. In another aspect, the processor 102 may be configured to derive one or more calibration values dynamically (e.g. from time to time) with the aid of one or more photosensors, for example. In various embodiments, the photosensor(s) may be one or more external components coupled to the lighting unit, or alternatively may be integrated as part of the lighting unit itself. A photosensor is one example of a signal source that may be integrated or otherwise associated with the lighting unit 100, and monitored by the processor 102 in connection with the operation of the lighting unit. Other examples of such signal sources are discussed further below, in connection with the signal source 124 shown in FIG. 1. One exemplary method that may be implemented by the processor 102 to derive one or more calibration values includes applying a reference control signal to a light source (e.g., corresponding to maximum output radiant power), and measuring (e.g., via one or more photosensors) an intensity of radiation (e.g., radiant power falling on the photosensor) thus generated by the light source. The processor may be programmed to then make a comparison of the measured intensity and at least one reference value (e.g., representing an intensity that nominally would be expected in response to the reference control signal). Based on such a comparison, the processor may determine one or more calibration values (e.g., scaling factors) for the light source. In particular, the processor may derive a calibration value such that, when applied to the reference control signal, the light source outputs radiation having an intensity that corresponds to the reference value (i.e., an “expected” intensity, e.g., expected radiant power in lumens). In various aspects, one calibration value may be derived for an entire range of control signal/output intensities for a given light source. Alternatively, multiple calibration values may be derived for a given light source (i.e., a number of calibration value “samples” may be obtained) that are respectively applied over different control signal/output intensity ranges, to approximate a nonlinear calibration function in a piecewise linear manner.

Still referring to FIG. 1, the lighting unit 100 optionally may include one or more user interfaces 118 that are provided to facilitate any of a number of user-selectable settings or functions (e.g., generally controlling the light output of the lighting unit 100, changing and/or selecting various pre-programmed lighting effects to be generated by the lighting unit, changing and/or selecting various parameters of selected lighting effects, setting particular identifiers such as addresses or serial numbers for the lighting unit, etc.). In various embodiments, the communication between the user interface 118 and the lighting unit may be accomplished through wire or cable, or wireless transmission.

In one implementation, the controller 105 of the lighting unit monitors the user interface 118 and controls one or more of the light sources 104A, 104B, 104C and 104D based at least in part on a user's operation of the interface. For example, the controller 105 may be configured to respond to operation of the user interface by originating one or more control signals for controlling one or more of the light sources. Alternatively, the processor 102 may be configured to respond by selecting one or more pre-programmed control signals stored in memory, modifying control signals generated by executing a lighting program, selecting and executing a new lighting program from memory, or otherwise affecting the radiation generated by one or more of the light sources.

In particular, in one implementation, the user interface 118 may constitute one or more switches (e.g., a standard wall switch) that interrupt power to the controller 105. In one aspect of this implementation, the controller 105 is configured to monitor the power as controlled by the user interface, and in turn control one or more of the light sources based at least in part on duration of a power interruption caused by operation of the user interface. As discussed above, the controller may be particularly configured to respond to a predetermined duration of a power interruption by, for example, selecting one or more pre-programmed control signals stored in memory, modifying control signals generated by executing a lighting program, selecting and executing a new lighting program from memory, or otherwise affecting the radiation generated by one or more of the light sources.

FIG. 1 also illustrates that the lighting unit 100 may be configured to receive one or more signals 122 from one or more other signal sources 124. In one implementation, the controller 105 of the lighting unit may use the signal(s) 122, either alone or in combination with other control signals (e.g., signals generated by executing a lighting program, one or more outputs from a user interface, etc.), so as to control one or more of the light sources 104A, 104B, 104C and 104D in a manner similar to that discussed above in connection with the user interface.

Examples of the signal(s) 122 that may be received and processed by the controller 105 include, but are not limited to, one or more audio signals, video signals, power signals, various types of data signals, signals representing information obtained from a network (e.g., the Internet), signals representing one or more detectable/sensed conditions, signals from lighting units, signals consisting of modulated light, etc. In various implementations, the signal source(s) 124 may be located remotely from the lighting unit 100, or included as a component of the lighting unit. In one embodiment, a signal from one lighting unit 100 could be sent over a network to another lighting unit 100.

Some examples of a signal source 124 that may be employed in, or used in connection with, the lighting unit 100 of FIG. 1 include any of a variety of sensors or transducers that generate one or more signals 122 in response to some stimulus. Examples of such sensors include, but are not limited to, various types of environmental condition sensors, such as thermally sensitive (e.g., temperature, infrared) sensors, humidity sensors, motion sensors, photosensors/light sensors (e.g., photodiodes, sensors that are sensitive to one or more particular spectra of electromagnetic radiation such as spectroradiometers or spectrophotometers, etc.), various types of cameras, sound or vibration sensors or other pressure/force transducers (e.g., microphones, piezoelectric devices), and the like.

Additional examples of a signal source 124 include various metering/detection devices that monitor electrical signals or characteristics (e.g., voltage, current, power, resistance, capacitance, inductance, etc.) or chemical/biological characteristics (e.g., acidity, a presence of one or more particular chemical or biological agents, bacteria, etc.) and provide one or more signals 122 based on measured values of the signals or characteristics. Yet other examples of a signal source 124 include various types of scanners, image recognition systems, voice or other sound recognition systems, artificial intelligence and robotics systems, and the like. A signal source 124 could also be a lighting unit 100, another controller or processor, or any one of many available signal generating devices, such as media players, MP3 players, computers, DVD players, CD players, television signal sources, camera signal sources, microphones, speakers, telephones, cellular phones, instant messenger devices, SMS devices, wireless devices, personal organizer devices, and many others.

In one embodiment, the lighting unit 100 shown in FIG. 1 also may include one or more optical elements or facilities 130 to optically process the radiation generated by the light sources 104A, 104B, 104C, and 104D. For example, one or more optical elements may be configured so as to change one or both of a spatial distribution and a propagation direction of the generated radiation. In particular, one or more optical elements may be configured to change a diffusion angle of the generated radiation. In one aspect of this embodiment, one or more optical elements 130 may be particularly configured to variably change one or both of a spatial distribution and a propagation direction of the generated radiation (e.g., in response to some electrical and/or mechanical stimulus). Examples of optical elements that may be included in the lighting unit 100 include, but are not limited to, reflective materials, refractive materials, translucent materials, filters, lenses, mirrors, and fiber optics. The optical element 130 also may include a phosphorescent material, luminescent material, or other material capable of responding to or interacting with the generated radiation.

As also shown in FIG. 1, the lighting unit 100 may include one or more communication ports 120 to facilitate coupling of the lighting unit 100 to any of a variety of other devices, including one or more other lighting units. For example, one or more communication ports 120 may facilitate coupling multiple lighting units together as a networked lighting system, in which at least some or all of the lighting units are addressable (e.g., have particular identifiers or addresses) and/or are responsive to particular data transported across the network. In another aspect, one or more communication ports 120 may be adapted to receive and/or transmit data through wired or wireless transmission. In one embodiment, information received through the communication port may at least in part relate to address information to be subsequently used by the lighting unit, and the lighting unit may be adapted to receive and then store the address information in the memory 114 (e.g., the lighting unit may be adapted to use the stored address as its address for use when receiving subsequent data via one or more communication ports).

In particular, in a networked lighting system environment, as discussed in greater detail further below (e.g., in connection with FIG. 2), as data is communicated via the network, the controller 105 of each lighting unit coupled to the network may be configured to be responsive to particular data (e.g., lighting control commands) that pertain to it (e.g., in some cases, as dictated by the respective identifiers of the networked lighting units). Once a given controller identifies particular data intended for it, it may read the data and, for example, change the lighting conditions produced by its light sources according to the received data (e.g., by generating appropriate control signals to the light sources). In one aspect, the memory 114 of each lighting unit coupled to the network may be loaded, for example, with a table of lighting control signals that correspond with data the processor 102 of the controller receives. Once the processor 102 receives data from the network, the processor may consult the table to select the control signals that correspond to the received data, and control the light sources of the lighting unit accordingly (e.g., using any one of a variety of analog or digital signal control techniques, including various pulse modulation techniques discussed above).

In one aspect of this embodiment, the processor 102 of a given lighting unit, whether or not coupled to a network, may be configured to interpret lighting instructions/data that are received in a DMX protocol (as discussed, for example, in U.S. Pat. Nos. 6,016,038 and 6,211,626), which is a lighting command protocol conventionally employed in the lighting industry for some programmable lighting applications. In the DMX protocol, lighting instructions are transmitted to a lighting unit as control data that is formatted into packets including 512 bytes of data, in which each data byte is constituted by 8-bits representing a digital value of between zero and 255. These 512 data bytes are preceded by a “start code” byte. An entire “packet” including 513 bytes (start code plus data) is transmitted serially at 250 kbit/s pursuant to RS-485 voltage levels and cabling practices, wherein the start of a packet is signified by a break of at least 88 microseconds.

In the DMX protocol, each data byte of the 512 bytes in a given packet is intended as a lighting command for a particular “channel” of a multi-channel lighting unit, wherein a digital value of zero indicates no radiant output power for a given channel of the lighting unit (i.e., channel off), and a digital value of 255 indicates full radiant output power (100% available power) for the given channel of the lighting unit (i.e., channel full on). For example, in one aspect, considering for the moment a three-channel lighting unit based on red, green and blue LEDs (i.e., an “R-G-B” lighting unit), a lighting command in DMX protocol may specify each of a red channel command, a green channel command, and a blue channel command as eight-bit data (i.e., a data byte) representing a value from 0 to 255. The maximum value of 255 for any one of the color channels instructs the processor 102 to control the corresponding light source(s) to operate at maximum available power (i.e., 100%) for the channel, thereby generating the maximum available radiant power for that color (such a command structure for an R-G-B lighting unit commonly is referred to as 24-bit color control). Hence, a command of the format [R, G, B]32 [255, 255, 255] would cause the lighting unit to generate maximum radiant power for each of red, green and blue light (thereby creating white light).

Thus, a given communication link employing the DMX protocol conventionally can support up to 512 different lighting unit channels. A given lighting unit designed to receive communications formatted in the DMX protocol generally is configured to respond to only one or more particular data bytes of the 512 bytes in the packet corresponding to the number of channels of the lighting unit (e.g., in the example of a three-channel lighting unit, three bytes are used by the lighting unit), and ignore the other bytes, based on a particular position of the desired data byte(s) in the overall sequence of the 512 data bytes in the packet. To this end, DMX-based lighting units may be equipped with an address selection mechanism that may be manually set by a user/installer to determine the particular position of the data byte(s) that the lighting unit responds to in a given DMX packet.

It should be appreciated, however, that lighting units suitable for purposes of the present disclosure are not limited to a DMX command format, as lighting units according to various embodiments may be configured to be responsive to other types of communication protocols/lighting command formats so as to control their respective light sources. In general, the processor 102 may be configured to respond to lighting commands in a variety of formats that express prescribed operating powers for each different channel of a multi-channel lighting unit according to some scale representing zero to maximum available operating power for each channel.

For example, in another embodiment, the processor 102 of a given lighting unit may be configured to interpret lighting instructions/data that are received in a conventional Ethernet protocol (or similar protocol based on Ethernet concepts). Ethernet is a well-known computer networking technology often employed for local area networks (LANs) that defines wiring and signaling requirements for interconnected devices forming the network, as well as frame formats and protocols for data transmitted over the network. Devices coupled to the network have respective unique addresses, and data for one or more addressable devices on the network is organized as packets. Each Ethernet packet includes a “header” that specifies a destination address (to where the packet is going) and a source address (from where the packet came), followed by a “payload” including several bytes of data (e.g., in Type II Ethernet frame protocol, the payload may be from 46 data bytes to 1500 data bytes). A packet concludes with an error correction code or “checksum.” As with the DMX protocol discussed above, the payload of successive Ethernet packets destined for a given lighting unit configured to receive communications in an Ethernet protocol may include information that represents respective prescribed radiant powers for different available spectra of light (e.g., different color channels) capable of being generated by the lighting unit.

In one embodiment, the lighting unit 100 of FIG. 1 may include and/or be coupled to one or more power sources 108. In various aspects, examples of power source(s) 108 include, but are not limited to, AC power sources, DC power sources, batteries, solar-based power sources, thermoelectric or mechanical-based power sources and the like. Additionally, in one aspect, the power source(s) 108 may include or be associated with one or more power conversion devices or power conversion circuitry (e.g., in some cases internal to the lighting unit 100) that convert power received by an external power source to a form suitable for operation of the various internal circuit components and light sources of the lighting unit 100. In one exemplary implementation, the controller 105 of the lighting unit 100 may be configured to accept a standard A.C. line voltage from the power source 108 and provide appropriate D.C. operating power for the light sources and other circuitry of the lighting unit based on concepts related to DC-DC conversion, or “switching” power supply concepts. In one aspect of such implementations, the controller 105 may include circuitry to not only accept a standard A.C. line voltage but to ensure that power is drawn from the line voltage with a significantly high power factor.

Additionally, one or more optical elements as discussed above may be partially or fully integrated with an enclosure/housing arrangement for the lighting unit. Furthermore, the various components of the lighting unit discussed above (e.g., processor, memory, power, user interface, etc.), as well as other components that may be associated with the lighting unit in different implementations (e.g., sensors/transducers, other components to facilitate communication to and from the unit, etc.) may be packaged in a variety of ways; for example, in one aspect, any subset or all of the various lighting unit components, as well as other components that may be associated with the lighting unit, may be packaged together. In another aspect, packaged subsets of components may be coupled together electrically and/or mechanically in a variety of manners.

FIG. 2 illustrates an example of a networked lighting system 200 according to one embodiment of the present disclosure. In the embodiment of FIG. 2, a number of lighting units 100, similar to those discussed above in connection with FIG. 1, are coupled together to form the networked lighting system. It should be appreciated, however, that the particular configuration and arrangement of lighting units shown in FIG. 2 is for purposes of illustration only, and that the disclosure is not limited to the particular system topology shown in FIG. 2.

Additionally, while not shown explicitly in FIG. 2, it should be appreciated that the networked lighting system 200 may be configured flexibly to include one or more user interfaces, as well as one or more signal sources such as sensors/transducers. For example, one or more user interfaces and/or one or more signal sources such as sensors/transducers (as discussed above in connection with FIG. 1) may be associated with any one or more of the lighting units of the networked lighting system 200. Alternatively (or in addition to the foregoing), one or more user interfaces and/or one or more signal sources may be implemented as “stand alone” components in the networked lighting system 200. Whether stand alone components or particularly associated with one or more lighting units 100, these devices may be “shared” by the lighting units of the networked lighting system. Stated differently, one or more user interfaces and/or one or more signal sources such as sensors/transducers may constitute “shared resources” in the networked lighting system that may be used in connection with controlling any one or more of the lighting units of the system.

As shown in the embodiment of FIG. 2, the lighting system 200 may include one or more lighting unit controllers (hereinafter “LUCs”) 208A, 208B, 208C, and 208D, wherein each LUC is responsible for communicating with and generally controlling one or more lighting units 100 coupled to it. Although FIG. 2 illustrates two lighting units 100 coupled to the LUC 208A, and one lighting unit 100 coupled to each LUC 208B, 208C and 208D, it should be appreciated that the disclosure is not limited in this respect, as different numbers of lighting units 100 may be coupled to a given LUC in a variety of different configurations (serially connections, parallel connections, combinations of serial and parallel connections, etc.) using a variety of different communication media and protocols.

In the system of FIG. 2, each LUC in turn may be coupled to a central controller 202 that is configured to communicate with one or more LUCs. Although FIG. 2 shows four LUCs coupled to the central controller 202 via a generic connection 204 (which may include any number of a variety of conventional coupling, switching and/or networking devices), it should be appreciated that according to various embodiments, different numbers of LUCs may be coupled to the central controller 202. Additionally, according to various embodiments of the present disclosure, the LUCs and the central controller may be coupled together in a variety of configurations using a variety of different communication media and protocols to form the networked lighting system 200. Moreover, it should be appreciated that the interconnection of LUCs and the central controller, and the interconnection of lighting units to respective LUCs, may be accomplished in different manners (e.g., using different configurations, communication media, and protocols).

For example, according to one embodiment of the present technology, the central controller 202 shown in FIG. 2 may by configured to implement Ethernet-based communications with the LUCs, and in turn the LUCs may be configured to implement one of Ethernet-based, DMX-based, or serial-based protocol communications with the lighting units 100 (as discussed above, exemplary serial-based protocols suitable for various network implementation are discussed in detail in U.S. Pat. No. 6,777,891. In particular, in one aspect of this embodiment, each LUC may be configured as an addressable Ethernet-based controller and accordingly may be identifiable to the central controller 202 via a particular unique address (or a unique group of addresses and/or other identifiers) using an Ethernet-based protocol. In this manner, the central controller 202 may be configured to support Ethernet communications throughout the network of coupled LUCs, and each LUC may respond to those communications intended for it. In turn, each LUC may communicate lighting control information to one or more lighting units coupled to it, for example, via an Ethernet, DMX, or serial-based protocol, in response to the Ethernet communications with the central controller 202 (wherein the lighting units are appropriately configured to interpret information received from the LUC in the Ethernet, DMX, or serial-based protocols).

According to one embodiment, the LUCs 208A, 208B, and 208C shown in FIG. 2 may be configured to be “intelligent” in that the central controller 202 may be configured to communicate higher level commands to the LUCs that need to be interpreted by the LUCs before lighting control information can be forwarded to the lighting units 100. For example, a lighting system operator may want to generate a color changing effect that varies colors from lighting unit to lighting unit in such a way as to generate the appearance of a propagating rainbow of colors (“rainbow chase”), given a particular placement of lighting units with respect to one another. In this example, the operator may provide a simple instruction to the central controller 202 to accomplish this, and in turn the central controller may communicate to one or more LUCs using an Ethernet-based protocol high level command to generate a “rainbow chase.” The command may contain timing, intensity, hue, saturation or other relevant information, for example. When a given LUC receives such a command, it may then interpret the command and communicate further commands to one or more lighting units using any one of a variety of protocols (e.g., Ethernet, DMX, serial-based), in response to which the respective sources of the lighting units are controlled via any of a variety of signaling techniques (e.g., PWM).

According to another embodiment, one or more LUCs of a lighting network may be coupled to a series connection of multiple lighting units 100 (e.g., see LUC 208A of FIG. 2, which is coupled to two series-connected lighting units 100). In one aspect of such an embodiment, each LUC coupled in this manner is configured to communicate with the multiple lighting units using a serial-based communication protocol, examples of which were discussed above. More specifically, in one exemplary implementation, a given LUC may be configured to communicate with a central controller 202, and/or one or more other LUCs, using an Ethernet-based protocol, and in turn communicate with the multiple lighting units using a serial-based communication protocol. In this manner, a LUC may be viewed in one sense as a protocol converter that receives lighting instructions or data in the Ethernet-based protocol, and passes on the instructions to multiple serially-connected lighting units using the serial-based protocol. Of course, in other network implementations involving DMX-based lighting units arranged in a variety of possible topologies, it should be appreciated that a given LUC similarly may be viewed as a protocol converter that receives lighting instructions or data in the Ethernet protocol, and passes on instructions formatted in a DMX protocol. It should again be appreciated that the foregoing example of using multiple different communication implementations (e.g., Ethernet/DMX) in a lighting system according to one embodiment of the present technology is for purposes of illustration only, and that the technology is not limited to this particular example.

From the foregoing, it may be appreciated that one or more lighting units as discussed above are capable of generating highly controllable variable color light over a wide range of colors, as well as variable color temperature white light over a wide range of color temperatures.

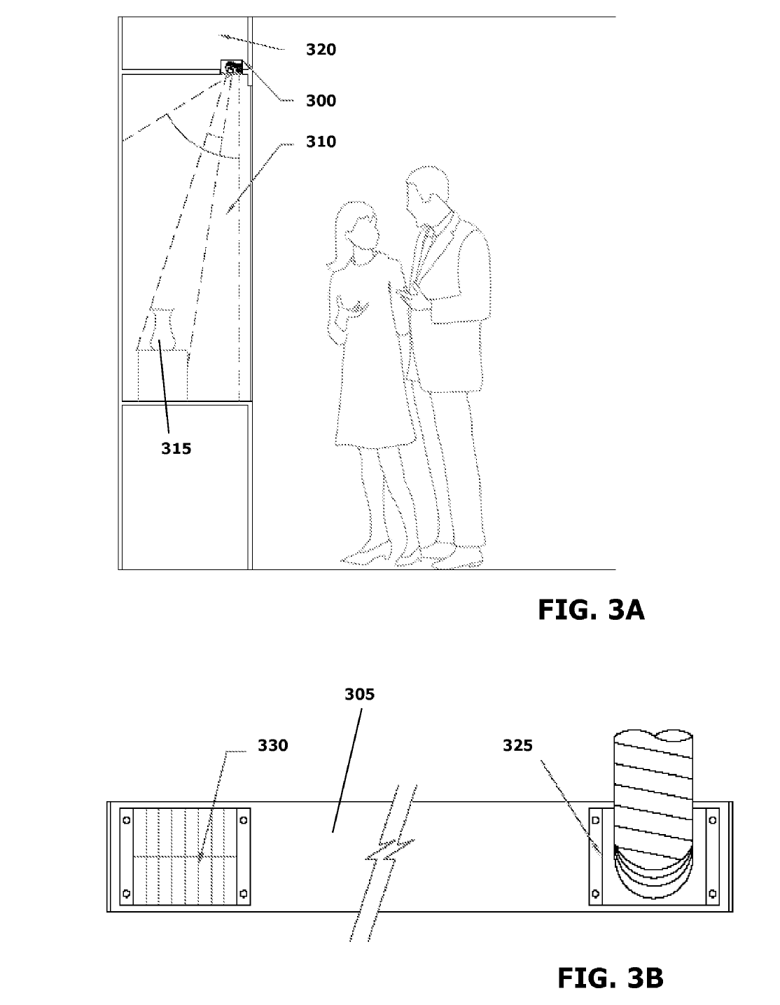

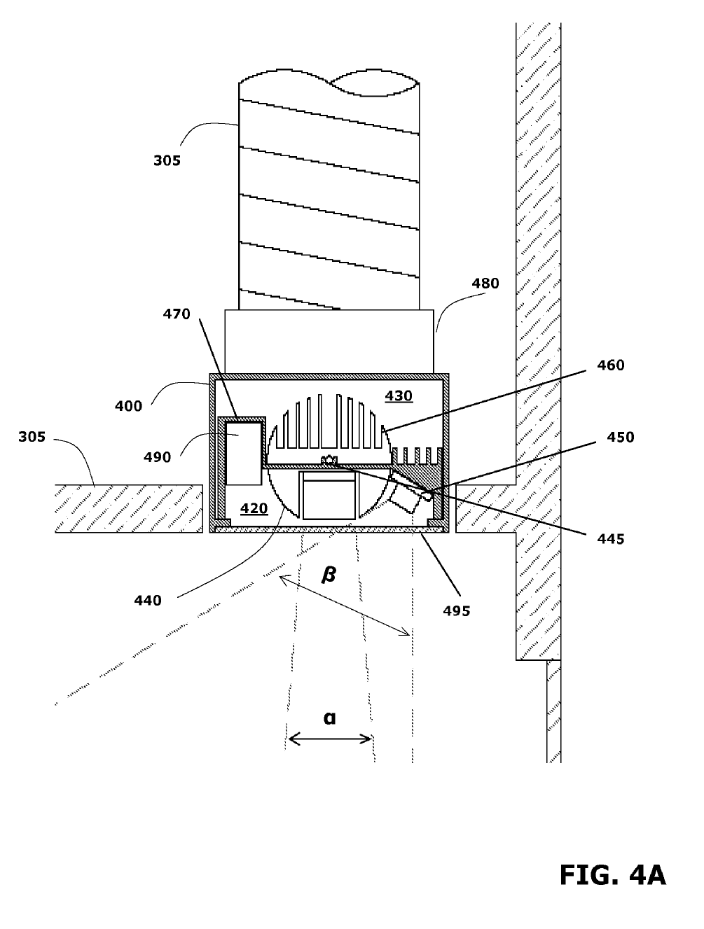

Referring now to FIGS. 3A-3B, in many implementations and embodiments of the present invention, an illumination system 300 is mounted over and secured within an aperture formed in a top surface 305 of the display case 310. For example, a housing of the illumination system 300 may have flanges on its sides (not shown) to facilitate mounting into the surface 305. The illumination system disclosed herein is configured to provide one or more forms of lighting, for example, general, diffuse illumination and adjustable, focused spot lighting for precise illumination of an artifact 315 on display. In various embodiments, one or more of the diffuse lighting units are generally fixed, while the spot lighting units are adjustably mounted, as discussed in more detail below.

In some implementations, a utility cabinet 320 is disposed over the case 310 for concealing the illumination system from the outside view. Referring to FIG. 3B, a flexible venting duct 325 can be disposed over the illumination system for venting the exhausted hot air from the illumination system to a desired location. An air filter 330 can be installed in the top surface 305 for air intake.

While the illumination system is depicted on top of the case for illustration purposes, the approach disclosed herein is not limited to any particular location or positioning of the illumination system. For example, the illumination system can be disposed on a sidewall of the display case. Furthermore, while discussed primarily in connection with illumination of museum-quality artifacts disposed in a display case, this technology is suitable to other applications where directing focused high-quality illumination into an enclosure is desirable without introducing undesirable heat.

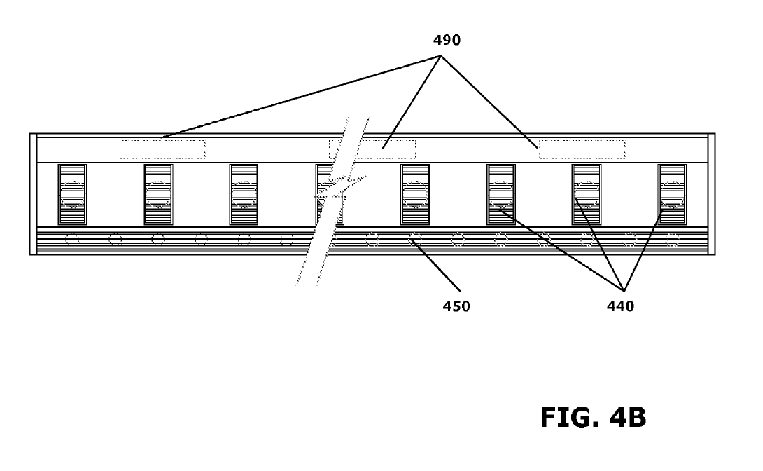

Referring to FIG. 4A, in various implementations of the present technology, the illumination system 300 includes a housing 400 shaped to be received and secured within an aperture in the surface 305. For example, as mentioned above the housing may have flanges on its sides (not shown). The housing is made of thermally resistant material, for example, thermoset polymer. The housing may have width W ranging from about 2″ to about 6″, for example, is about 4″ wide; and height H ranging from about 2.5″ to about 5″, for example, is about 3.5″ high. The housing is separated into two chambers in relation to the display case or other enclosure containing objects to be illuminated, a proximal chamber 420 and a distal chamber 430.

The system further includes at least one first lighting unit 440 and at least one second lighting unit 450, such as those discussed above in connection with FIGS. 1-2. Each of the lighting units includes a first plurality of LED light sources and adapted to generate at least first radiation having a first spectrum. In some implementations, at least one of the lighting units also includes a second plurality of LED light sources adapted to generate at least second radiation having a second spectrum different than the first spectrum. In some implementations, the first lighting unit 440 has an adjustable orientation, for example, si rotatable about an axis 445, for directing a beam of light at a desired limited area within the case (for example, providing spot illumination of the artifact within the display case), while the second lighting unit 450 is fixed for providing general ambient or diffuse illumination of the interior of the case. The unit 440 includes a heat-dissipating portion 460, for example, consisting of a plurality of fins and made of a heat-conductive material, such as aluminum.

A partition 470 separating the chambers is configured to facilitate mounting of lighting units thereon in a desired orientation. The partition also serves to dissipate heat from the fixed lighting unit 450 attached thereto and, therefore, is made of, for example, aluminum or other thermally conductive material. The partition may include a plurality of fins formed on the opposite side of the attachment location for the lighting unit 450. An opening is formed through the partition for receiving the lighting unit 440, such that the heat-dissipating portion 460 of the lighting unit(s) 440, when attached to the partition, is disposed in the distal chamber. In some embodiments, adjustable yoke and gimble pivots are provided to facilitate rotation of the unit(s) 440 about the axis 445.

Still referring to FIG. 4A, in some embodiments, the illumination system further includes an cooling module, for example, an exhaust fan 480 for cooling the heat-dissipating portion 460 of the lighting unit 440 and the partition 470 in the distal chamber by forced-air convection, whereby the heat is drawn up and away from the enclosure. Thus, the invention contemplates creating an airflow through the distal chamber but not through the proximal chamber, thereby enhancing conductive heat transfer from the LED light sources to the heat-dissipating member and enhancing convective heat transfer from the heat-dissipating member to the ambient

In one embodiment, the system also includes a single control module 490 for controlling the light sources of both the lighting units 440, 450, as described above in connection with FIGS. 1-2. The control module is disposed in the proximal chamber and attached to the partition without interfering with the lighting units 440, 450. In another embodiment, each lighting unit is controlled by a dedicated control module.

A light-transmissive panel 495 sealably separates the proximal chamber from the enclosure to prevent dust infiltration and provide additional thermal insulation. The light-transmissive panel is preferably removable or pivotable to enable access to the control module and the lighting units for adjustment and maintenance.

Referring now to FIG. 4B, as well as to FIG. 4A, in some implementations, the system 300 utilizes a plurality of rotatable lighting units 440 to provide spot illumination for several artifacts. Each unit 440 employs narrow-angle optics, for example, providing beam angle α ranging from about 5° to about 20°. In one particular embodiment, the beam angle α is about 10°. Thus, the unit 440 is capable of directing a light beam at a desired limited area within the case, for example, to provide spot illumination of a particular artifact within the case or a specific area therein. The lighting unit 450 preferably employs wide-angle optics—for example, with beam angle β ranging from about 40° to about 70° for providing general ambient illumination. A light-diffusing material can also be used. In some implementations, the lighting unit 450 is a linear fixture.

Having thus described several illustrative embodiments and implementations, it is to be appreciated that various alterations, modifications, and improvements will readily occur to those skilled in the art. Such alterations, modifications, and improvements are intended to be part of this disclosure, and are intended to be within the spirit and scope of this disclosure. While some examples presented herein involve specific combinations of functions or structural elements, it should be understood that those functions and elements may be combined in other ways according to the present disclosure to accomplish the same or different objectives. In particular, acts, elements, and features discussed in connection with one embodiment or implementation are not intended to be excluded from similar or other roles in other embodiments. Accordingly, the foregoing description and attached drawings are by way of example only, and are not intended to be limiting.

1. An illumination system (300) for illuminating one or more heat-sensitive objects disposed in a display case, the illumination system comprising:
a thermally insulated housing (400) comprising a partition (470) at least partially defining a proximal chamber (420) and a distal chamber (430) of the housing;
a first lighting unit (440) attached to the partition and disposed within the housing, the first lighting unit comprising a first plurality of LED light sources disposed within the proximal chamber and configured to generate a first radiation having a first spectrum for illuminating the one or more objects;
a control module (490) for controlling at least the first plurality of LED light sources;
a first heat-dissipating member (460) at least partially disposed within the distal chamber in thermal communication with the first plurality of LED light sources; and
a cooling system (480) configured to cause an airflow through the distal chamber (430).

2. The illumination system of claim 1, wherein the first lighting unit further comprises a second plurality of LED light sources adapted to generate a second radiation having a second spectrum different from the first spectrum.

3. The illumination system of claim 1, further comprising a second lighting unit (450) attached to the partition and disposed within the housing, the second lighting unit comprising a third plurality of LED light sources configured to generate a third radiation having a third spectrum for illuminating the one or more objects.

4. The illumination system of claim 3, wherein the second lighting unit is configured to generate a light beam having a beam angle within a range of 40 to 70 degrees for providing ambient illumination within the display case.

5. The illumination system of claim 3, wherein the control module (490) further controls the third plurality of LED light sources.

6. The illumination system of claim 5, wherein the third spectrum is equal to the first spectrum.

7. The illumination system of claim 1, wherein the first lighting unit is attached to the partition with an adjustable orientation so as to direct a light beam at a desired limited area within the case.

8. The illumination system of claim 7, wherein the light beam has a beam angle within a range of 5 to 20 degrees.

9. The illumination system of claim 8, wherein the light beam has a beam angle of about 10 degrees.

10. The illumination system of claim 1, wherein the partition is thermally conductive and defines a second heat-dissipating member comprising a plurality of fins.

11. The illumination system of claim 1, further comprising a thermally insulating light-transmissive panel (495) attached to the housing for transmitting at least the first radiation.

12. The illumination system of claim 11, wherein the light-transmissive panel is at least partially removable for providing access at least to the first lighting unit and the control module.

13. The illumination system of claim 11, wherein the cooling system comprises a fan.

14. A housing for securing at least one lighting unit and at least one control module for illuminating at least one heat-sensitive object, the housing comprising:
opposing side walls;
a top wall connected to the side walls;
a partition extending between the side walls and opposing the top wall, the partition being adapted to receive the at least one lighting unit and the at least one control module;
wherein the opposing side walls, the top wall, and a first surface of the partition define a distal chamber and a first pair of opposing openings for allowing air flow through the distal chamber;
wherein the opposing side walls and a second surface of the partition define a proximal chamber and a second pair of opposing openings; and
a pair of opposing end walls covering only the second pair of opposing openings for preventing airflow through the proximal chamber.

15. A method for illuminating a heat-sensitive object within a display case, the method comprising:
(a) providing a housing defining a proximal chamber proximate to the heat-sensitive object and a distal chamber distal from the heat-sensitive object;
(b) disposing within the housing at least one lighting unit having a plurality of LED light sources and a heat-dissipating member in thermal communication with the plurality of LED light sources, such that the heat-dissipating member is disposed within the distal chamber;
(c) causing the plurality of LED light sources to direct a light beam towards the heat-sensitive object;
(d) creating an airflow through the distal chamber but not through the proximal chamber, thereby enhancing conductive heat transfer from the LED light sources to the heat-dissipating member and enhancing convective heat transfer from the heat-dissipating member to the ambient; and
(e) thereafter, exhausting the heated air away from the heat-sensitive object.

16. The method of claim 15, wherein the plurality of LED light sources are configured to generate radiation having a variable spectrum.

17. The method of claim 16, wherein step (c) further comprises controlling the radiation generated by the plurality of LED light sources to select a desirable spectrum.

18. The method of claim 15, further comprising providing diffuse illumination within the case.
